(19) United States
(12) Patent Application Publication
(10) Pub. No.: US 2005/0140603 A1
(43) Pub. Date: Jun. 30, 2005

(54) Light emitting display device and display panel thereof

(76) Inventors: Hong-Kwon Kim, Suwon-si (KR); Kyoung-Do Kim, Suwon-si (KR)

Correspondence Address: MCGUIREWOODS, LLP, 1750 TYSONS BLVD, SUITE 1800, MCLEAN, VA, 22102, US

(21) Appl. No.: 10/976,785

(22) Filed: Nov. 1, 2004

(30) Foreign Application Priority Data
Nov. 29, 2003 (KR) 10-2003-0086118

(51) Int. Cl. G09G 3/30

(52) U.S. Cl. 345/76

(57) ABSTRACT

A light emitting display device is disclosed that includes: a display panel having a plurality of pixel circuits arranged in a matrix; a plurality of power supply lines coupled to the pixel circuits, for applying a first voltage; and a conductive bar having one terminal coupled to a power for supplying the first voltage, and connected to at least one surface of the display panel, to transmit the first voltage to the power supply lines.

### CROSS REFERENCE TO RELATED APPLICATION

This application claims priority to Korea Patent Application No. 2003-0086118 filed on Nov. 29, 2003 in the Korean Intellectual Property Office, the disclosure of which is herein incorporated by reference in its entirety.

### BACKGROUND OF THE INVENTION

1. Field of the Invention

The present invention relates to a light emitting display device. More specifically, the present invention relates to an organic EL (electroluminescent) display device for uniformly applying a power supply voltage to a display panel.

2. Description of the Related Art

In general, an organic EL display electrically excites a phosphorous organic compound to emit light, and it voltage-programs or current-programs a N×M matrix of organic emitting cells to display images. Each organic emitting cell includes an anode (ITO), an organic thin film, and a cathode layer (metal). The organic thin film has a multi-layer structure including an EML (emitting layer), an ETL (electron transport layer), and an HTL (hole transport layer) for maintaining balance between electrons and holes and improving emitting efficiencies, and it further comprises an EIL (electron injecting layer) and an HIL (hole injecting layer).

FIG. 1 shows a conventional organic EL display device.

As shown, the organic EL display device includes an organic EL display panel (referred to as a display panel hereinafter) 100, a data driver 200, and a scan driver 300.

The display panel 100 comprises a plurality of data lines D₁ to Dₘ arranged in the column direction, a plurality of scan lines S₁ to Sₙ arranged in the row direction, and a plurality of pixel circuits arranged in a matrix.

The pixel circuit comprises a driving transistor 20 for controlling the current flowing to an organic EL element 40, a switching transistor 10 for applying a voltage at the data line D₁ to a gate of the driving transistor 20 in response to a select signal provided from the scan line S₁, and a capacitor 30 coupled between the gate and a source of the driving transistor 20. The source of the driving transistor 20 is coupled to a power supply line 11 for transmitting a power supply voltage V_{DD}.

The data driver 200 applies a data signal to the data lines D₁ to Dₘ, and the scan driver 300 sequentially applies a select signal for selecting a pixel circuit to the scan lines S₁ to Sn.

FIG. 2 shows the power supply lines 11 formed on the display panel 100 in the organic EL display device shown in FIG. 1.

As shown, the power supply lines 11 for supplying a power supply voltage to each pixel circuit are coupled to a power pad 12 of the display panel 100, and the power pad 12 transmits the externally supplied power supply voltage of V_{DD} to the respective power supply lines 11.

The current flowing to the power pad 12 increases as the display device becomes larger. In a large display, the power supply voltage supplied to the whole panel may not become uniform when voltage drops due to a parasitic resistance of the power pad 12 that supplies the power supply voltage, V_{DD}. Accordingly, a thicker and wider power pad 12 must be made in order to reduce the voltage drop generated in the power pad 12.

FIG. 3 shows the width of the power pad 12 for maintaining the voltage drop of the power pad 12 at a constant level in the conventional display device.

In FIG. 3, (a) indicates the width of the power pad 12 for maintaining the voltage drop of the power pad 12 at the voltage of 0.01V, and (b) depicts the width of the power pad 12 for maintaining the voltage drop at the voltage of 0.1V.

As known from FIG. 3, the power pad 12 must be made wider in order to supply a constant power supply voltage to the display panel 100. However, it is difficult to apply the power pad 12 to an actual display device since the required width of the power pad 12 substantially increases as the size of the display panel becomes larger.

### SUMMARY OF THE INVENTION

One embodiment of the present invention provides a uniform power supply voltage to a panel of a large display device.

In a preferred implementation, a light emitting display device includes a display panel having a plurality of pixel circuits arranged in a matrix. A plurality of power supply lines are coupled to the pixel circuits to apply a first voltage. A conductive bar having one terminal coupled to a power source for supplying the first voltage, and being connected to at least one surface of the display panel, transmits the first voltage to the power supply lines.

The conductive bar is adhered to at least one surface of the display panel by a ball-type epoxy film or a conductive film. A protrusion is formed on the display panel, and a groove for inserting the protrusion is formed on the conductive bar. The conductive bar is coupled to the top and the bottom of the display panel to supply power to the display panel.

In another aspect of the present invention, a display panel includes: a plurality of pixel circuits arranged in a matrix; a plurality of power supply lines coupled to the pixel circuits for applying a first voltage; and a conductive bar having one terminal coupled to a power source for supplying the first voltage, the conductive bar transmitting the first voltage to the power supply lines.

In still another embodiment of the present invention, a light emitting display device includes a display panel having a plurality of scan lines. A plurality of data lines crosses the scan lines. A plurality of pixel circuits is coupled to the scan lines and the data lines. A plurality of power supply lines applies a first voltage to the pixel circuits. A data driver supplies a data voltage to the data lines, and a scan driver applies a select signal to the scan lines. Additionally, the display panel includes a power pad. The power pad is formed to surround the display panel, which is coupled to a power source for supplying the first voltage, and transmits the first voltage to the power supply lines.

In still yet another aspect of the present invention, a display panel of a light emitting display panel that has a plurality of pixel circuits arranged in a matrix, includes: a data line for applying a data signal to the pixel circuit; a scan line for applying a scan signal to the pixel circuit; and a power supply line for applying a first voltage to the pixel circuit. Additionally, the power supply line is coupled to a conductive bar that has a predetermined volume, and the conductive bar transmits the first voltage supplied by an external power source to the power supply line.

### BRIEF DESCRIPTION OF THE DRAWINGS

The accompanying drawings, which are incorporated in and constitute a part of the specification, illustrate an embodiment of the invention, and, together with the description, serve to explain the principles of the invention.

FIG. 1 shows a conventional organic EL display device.

FIG. 2 shows power supply lines formed on a display panel in the organic EL display device shown in FIG. 1.

FIG. 3 shows the thickness of the power pad for maintaining the voltage drop of the power pad at a constant level in the conventional display device shown in FIG. 1.

FIG. 4 shows a light emitting display device according to a first exemplary embodiment of the present invention.

FIG. 5 shows a light emitting display device according to a second exemplary embodiment of the present invention.

FIG. 6 shows a light emitting display device according to a third exemplary embodiment of the present invention.

FIG. 7 shows a light emitting display device according to a fourth exemplary embodiment of the present invention.

FIG. 8 shows a light emitting display device according to a fifth exemplary embodiment of the present invention.

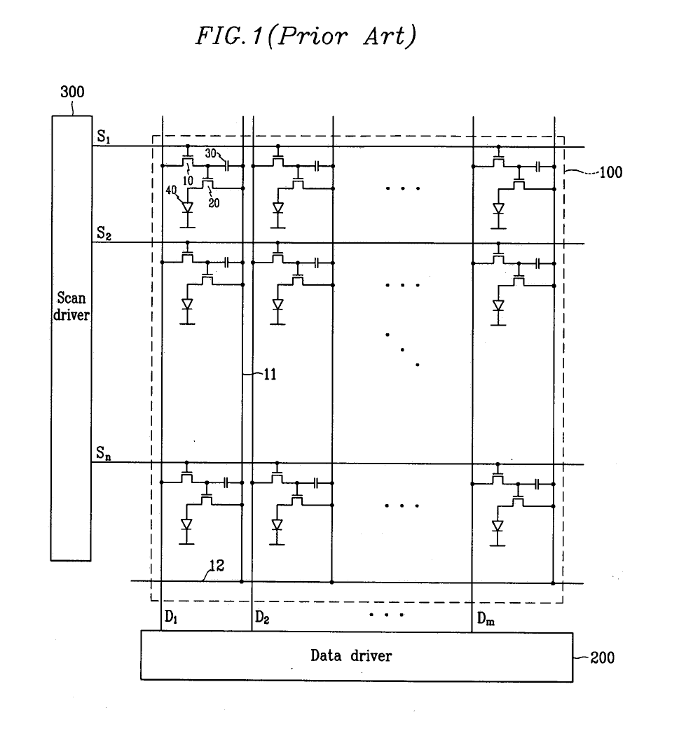

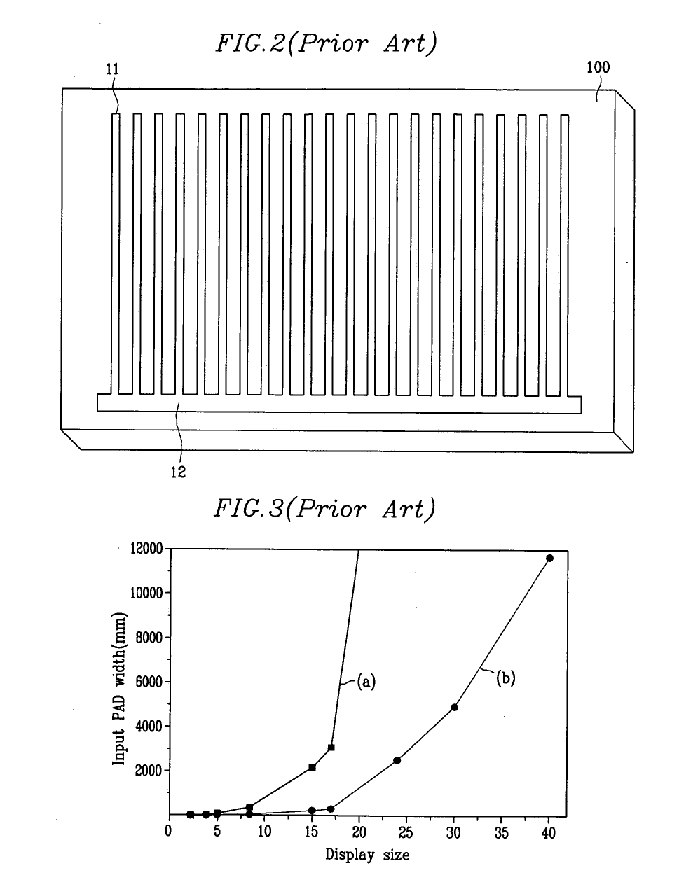

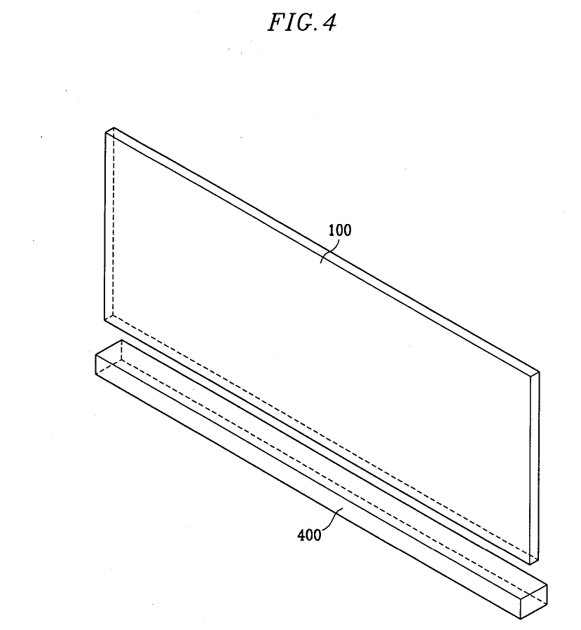

### DETAILED DESCRIPTION OF THE PREFERRED EMBODIMENTS

In the following detailed description, only the preferred embodiment of the invention has been shown and described, simply illustrating the best mode contemplated by the inventor(s) of carrying out the invention. As will be realized, the invention can be modified in various obvious respects, all without departing from the invention. Accordingly, the drawings and description are to be regarded as illustrative in nature, and not restrictive.

To couple one thing to another includes to directly couple the first one to the second one and to couple the first one to the second one with a third one provided therebetween. To clarify the present invention, parts which are not described in the specification are omitted, and parts for which similar descriptions are provided have the same reference numerals.

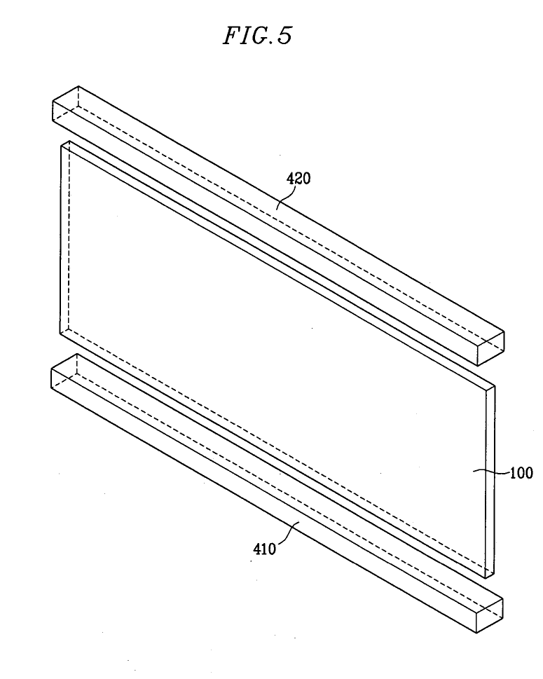

Referring to FIGS. 4, 5 and 6, a light emitting display device with a conductive bar which is combined in the outside of a panel will be described. FIGS. 4, 5 and 6 illustrate a light emitting display device according to first, second and third exemplary embodiments of the present invention.

As shown in FIG. 4, the light emitting display device according to the first exemplary embodiment includes a display panel 100 and a conductive bar 400 which are adhered to each other by an epoxy film or a conductive film.

The conductive bar 400 is adhered to the display panel 100 and functions as a power pad. Thus the externally supplied power supply voltage of V_{DD} to be applied to the respective pixel circuits of the display panel 100 is supplied to part of the conductive bar 400.

Since the conductive bar 400 is conductive matter with a predetermined volume, its internal resistance is small. Thus the conductive bar 400 will generate a much smaller voltage drop compared to a conventional power pad, and will apply a substantially uniform voltage to the pixel circuits.

The power supply line can be formed up to the bottom of the display panel. Also, the power pad for coupling the power supply lines may be formed on the display panel 100 and coupled to the conductive bar 400 so that the power supply lines for supplying the power to the respective pixel circuits are coupled to the conductive bar 400.

Also, a protrusion may be formed on the display panel 100 and a groove for inserting the protrusion may be formed on the conductive bar 400 to couple the display panel 100 to the conductive bar 400. Using the additional conductive bar 400 reduces the voltage drop generated by the power pad.

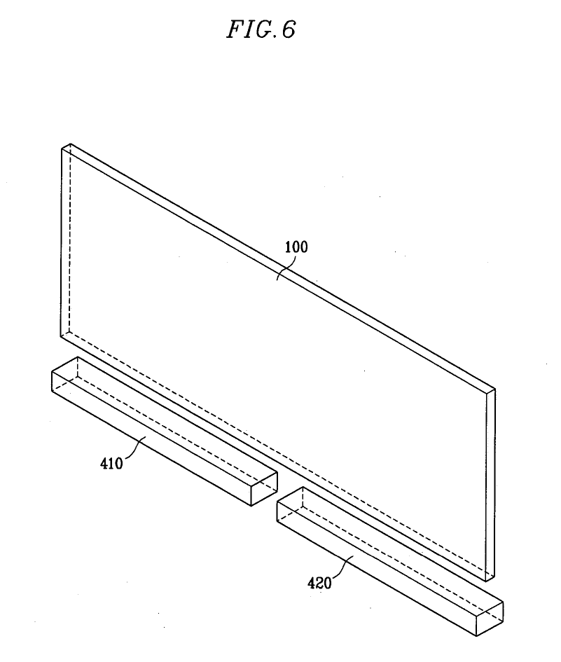

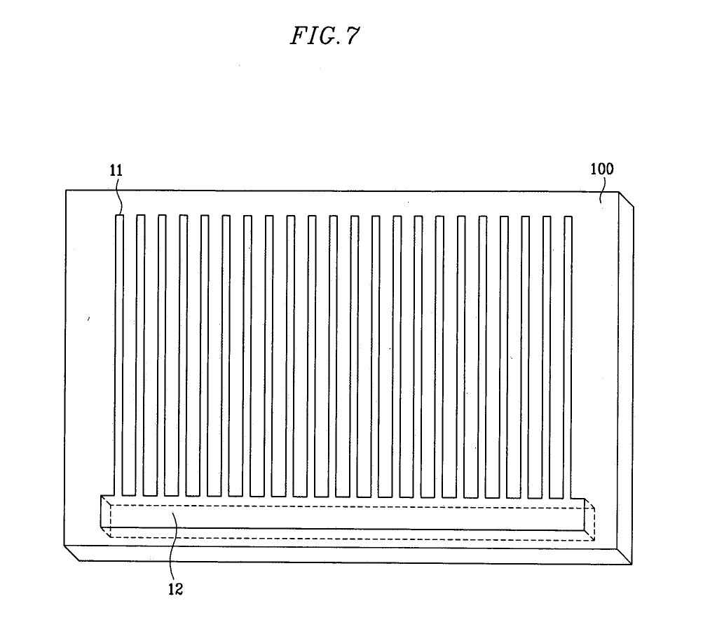

In FIG. 4, the conductive bar 400 is illustrated as coupled to the bottom of the display panel 100. Additionally, two conductive bars 410 and 420 may be coupled to the top and the bottom of the display panel 100, respectively, as shown in FIG. 5. Further, a plurality of conductive bars 410 and 420 can be coupled to the bottom of the display panel 100, as shown in FIG. 6.

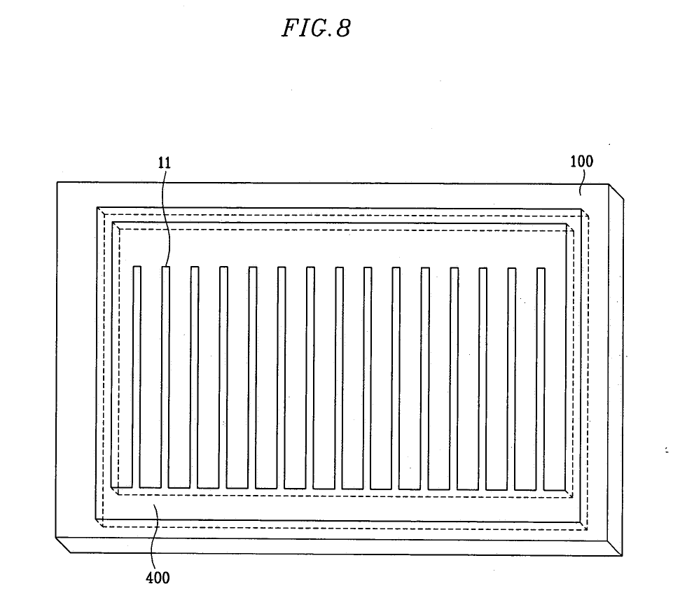

FIG. 7 shows a light emitting display device according to a fourth exemplary embodiment of the present invention.

The light emitting display device according to the fourth embodiment is different from the first, second and third embodiments in that a groove is formed on one part of the display panel 100, and the conductive bar 400 is inserted into the groove, thereby forming a power pad.

Specifically, a groove is formed in the row direction on the top or bottom of the display panel 100, and the conductive bar 400 is inserted into the groove to couple the conductive bar 400 and the power supply line 11.

Using the conductive bar 400 as the power pad 12 reduces the voltage drop which may be generated in the power pad.

As an applied example of the fourth embodiment, a groove is formed on the top panel to form a conductive bar, and the conductive bar is coupled to a power supply line formed on the bottom panel.

FIG. 8 shows a light emitting display device according to a fifth exemplary embodiment of the present invention. As shown, a conductive polymer made of rubber may be used for the conductive bar 400 to surround the display panel 100, and convert to the power supply lines 11. When the display panel 100 is surrounded by the conductive polymer, the voltage drop in the power pad is reduced, and the display panel surrounded by the conductive polymer advantageously functions as a spacer between the top panel and the bottom panel.

While the invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

1. A light emitting display device, comprising:
a display panel including a plurality of pixel circuits arranged in a matrix;
a plurality of power supply lines, coupled to the pixel circuits, for applying a first voltage; and
a conductive bar having one terminal coupled to a power source for supplying the first voltage, and being connected to at least one surface of the display panel, the conductive bar transmitting the first voltage to the power supply lines.

2. The light emitting display device of claim 1, wherein the conductive bar is adhered to at least one surface of the display panel by a ball-type epoxy film or a conductive film.

3. The light emitting display device of claim 1, wherein a protrusion is formed on the display panel, and a groove for inserting the protrusion is formed on the conductive bar.

4. The light emitting display device of claim 1, wherein the conductive bar is coupled to a top and a bottom of the display panel to supply power.

5. A display panel, comprising:
a plurality of pixel circuits arranged in a matrix;
a plurality of power supply lines, coupled to the pixel circuits, for applying a first voltage; and
a conductive bar having one terminal coupled to a power source for supplying the first voltage, the conductive bar transmitting the first voltage to the power supply lines.

6. The display panel of claim 5, wherein a groove for inserting the conductive bar is formed on the display panel.

7. The display panel of claim 5, wherein the conductive bar comprises a plurality of sub conductive bars having different lengths.

8. A light emitting display device, comprising:
a display panel including a plurality of scan lines, a plurality of data lines crossing the scan lines, a plurality of pixel circuits coupled to the scan lines and the data lines, and a plurality of power supply lines for applying a first voltage to the pixel circuits;
a data driver for supplying a data voltage to the data lines; and
a scan driver for applying a select signal to the scan lines,
wherein a power pad coupled to a power for supplying the first voltage to transmit the first voltage to the power supply lines is formed to surround the display panel.

9. The light emitting display device of claim 8, wherein the power pad is made of conductive polymer.

10. The light emitting display device of claim 8, wherein the pixel circuit comprises:
a light emitting element for emitting light in correspondence to an amount of applied current;
a transistor having a first electrode, a second electrode coupled to the power supply line, and a third electrode coupled to the light emitting element, the transistor outputting a current which corresponds to a voltage applied between the first and second electrodes to the third electrode;
a switch for applying the data voltage applied to the data line to the first electrode of the driving transistor; and
a capacitor coupled between the first electrode and the second electrode of the transistor.

11. A display panel of a light emitting display device including a pixel circuit arranged in a matrix, comprising:
a data line for applying a data signal to the pixel circuit;
a scan line for applying a scan signal to the pixel circuit; and
a power supply line for applying a first voltage to the pixel circuit,
wherein the power supply line is coupled to a conductive bar that has a predetermined volume, and the conductive bar transmits the first voltage supplied by an external power to the power supply line.

12. The display panel of claim 11, wherein the pixel circuit comprises:
a light emitting element for emitting light in correspondence to an amount of applied current;
a transistor having a first electrode, a second electrode coupled to the power supply line, and a third electrode coupled to the light emitting element, the transistor outputting a current which corresponds to a voltage applied between the first and second electrodes to the third electrode;
a switch for applying the data voltage applied to the data line to the first electrode of the driving transistor; and
a capacitor coupled between the first electrode and the second electrode of the transistor.
